(19) United States
(12) Patent Application Publication
(10) Pub. No.: US 2011/0116705 A1
(43) Pub. Date: May 19, 2011

(54) METHOD OF MEASURING FOCAL VARIATIONS OF A PHOTOLITHOGRAPHY APPARATUS AND A METHOD OF FABRICATING A SEMICONDUCTOR DEVICE USING THE FOCAL VARIATIONS MEASURING METHOD

(76) Inventors: Jin-Seok Heo, Suwon-si (KR); Jeong-Ho Yeo, Suwon-si (KR)

(21) Appl. No.: 12/862,430

(22) Filed: Aug. 24, 2010

(30) Foreign Application Priority Data
Nov. 17, 2009 (KR) 10-2009-0111015

(51) Int. Cl. G06T 7/00

(52) U.S. Cl. 382/145

(57) ABSTRACT

Provided are a method of measuring focal variations of a photolithography apparatus and a method of fabricating a semiconductor device using the method. The method of measuring the focal variations of the photolithography apparatus includes loading a photomask and a wafer into the photolithography apparatus. The photomask has an optical pattern, and the wafer has a photoresist layer on a top surface thereof. An image of the optical pattern is transferred to the photoresist layer using ultraviolet (UV) light. The photoresist layer is baked. The photoresist layer is inspected. Inspection results of the photoresist layer are analyzed. The inspection of the photoresist layer includes irradiating light for measurement to the entire surface of the wafer. Light reflected and diffracted by the wafer is collected to form an optical image. The analysis of the inspection results of the photoresist layer includes analyzing optical information on the optical image.

### CROSS-REFERENCE TO RELATED APPLICATION

This application claims priority under 35 U.S.C. §119 to Korean Patent Application No. 10-2009-0111015, filed on Nov. 17, 2009, the disclosure of which is incorporated by reference herein in its entirety.

### BACKGROUND

1. Technical Field

Exemplary embodiments of the inventive concept relate to a method of measuring focal variations of a photolithography apparatus used for fabrication of semiconductor devices and a method of fabricating a semiconductor device using the focal variations measuring method.

2. Discussion of Related Art

With an increase in the integration density of semiconductor devices and the shrinkage of patterns, a method of stably maintaining the focus of a photolithography apparatus used for fabrication of semiconductor devices and determining an appropriate focal position has lately emerged as an important issue.

### SUMMARY

Exemplary embodiments of the inventive concept provide a method of measuring the influence of a focal variation of a photolithography apparatus.

In addition, exemplary embodiments of the inventive concept provide a method of fabricating a semiconductor device using a method of measuring a focal variation of a photolithography apparatus.

Aspects of the inventive concept should not be limited by the above description, and other unmentioned aspects will be clearly understood by one of ordinary skill in the art from exemplary embodiments of the inventive concept described herein.

According to exemplary embodiments of the inventive concept, a method of measuring focal variations of a photolithography apparatus includes loading a photomask and a wafer into the photolithography apparatus. The photomask has an optical pattern, and the wafer has a photoresist layer on a top surface thereof. An image of the optical pattern is transferred to the photoresist layer using ultraviolet (UV) light. The photoresist layer is baked. The photoresist layer is inspected. Inspection results of the photoresist layer are analyzed. The inspection of the photoresist layer includes: irradiating light for measurement to the entire surface of the wafer; and collecting light reflected and diffracted by the wafer to form an optical image. The analysis of the inspection results of the photoresist layer includes analyzing optical information on the optical image.

According to exemplary embodiments of the inventive concept, a method of measuring focal variations of a photolithography apparatus includes loading a photomask and a wafer into a photolithography apparatus. The photomask has an optical pattern, and the wafer has a photoresist layer on a top surface thereof. An image of the optical pattern is transferred to the photoresist layer using UV light. The photoresist layer is baked. The photoresist layer is inspected without developing the photoresist layer. Inspection results of the photoresist layer are analyzed. The inspection of the photoresist layer includes: irradiating visible (V) light for measurement to the entire photoresist layer; and collecting light reflected and diffracted by the wafer to form an optical image. The analysis of the inspection results of the photoresist layer includes analyzing optical information on the optical image.

According to exemplary embodiments of the inventive concept, a method of fabricating a semiconductor device includes inspecting focal variations of a photolithography apparatus. A wafer having a material layer and a photoresist layer on a surface thereof is loaded into the photolithography apparatus. The photoresist layer is irradiated with UV light. The photoresist layer is developed to form a photoresist pattern. The material layer is patterned using the photoresist pattern as a patterning mask to form a material layer pattern. The photoresist pattern is removed. The wafer is cleaned. The inspection of the focal variations of the photolithography apparatus includes loading a photomask and a wafer into the photolithography apparatus. The photomask has an optical pattern, and the wafer has a photoresist layer on a top surface thereof. An image of the optical pattern is transferred to the photoresist layer using ultraviolet (UV) light. The photoresist layer is baked. The photoresist layer is inspected. Inspection results of the photoresist layer are analyzed. The inspection of the photoresist layer includes: irradiating light for measurement to the entire surface of the wafer; and collecting light reflected and diffracted by the wafer to form an optical image. The analysis of the inspection results of the photoresist layer includes analyzing optical information on the optical image.

Particulars of the above and other exemplary embodiments of the inventive concepts are included in the detailed description and drawings.

### BRIEF DESCRIPTION OF THE DRAWINGS

Exemplary embodiments of the inventive concept are described in further detail below with reference to the accompanying drawings. It should be understood that various aspects of the drawings may have been exaggerated for clarity:

FIG. 1 is a flowchart illustrating a method of measuring focal variations of a photolithography apparatus according to exemplary embodiments of the inventive concept;

FIGS. 2A through 2D are schematic diagrams illustrating the method of FIG. 1;

FIG. 3 is a graphic image taken while varying the focus of a photolithography apparatus according to exemplary embodiments of the inventive concept;

FIGS. 4A through 4C are graphic images of data extracted from the graphic image of FIG. 3 according to red, green and blue (RGB) colors;

FIG. 5 is a graphic image taken while varying the focus of a photolithography apparatus according to exemplary embodiments of the inventive concept;

FIG. 6 is an image of an R brightness element extracted from the graphic image of FIG. 5;

FIG. 7 is a graph showing the image of FIG. 6 according to a shot region;

FIG. 8 is a black-and-white graphic image showing conversion of a graphic image obtained according to exemplary embodiments of the inventive concept into a grayscale image;

FIG. 9 is a flowchart illustrating a method of fabricating a semiconductor device using a method of measuring focal variations of a photolithography apparatus according to exemplary embodiments of the inventive concept; and

FIGS. 10A through 10D are schematic diagrams illustrating the method of FIG. 9.

### DETAILED DESCRIPTION OF THE EMBODIMENTS

Various exemplary embodiments of the inventive concept will now be described more fully with reference to the accompanying drawings in which some exemplary embodiments are shown. This inventive concept may, however, be embodied in different forms and should not be construed as limited to the embodiments set forth herein. Rather, these embodiments are provided so that this disclosure is thorough and complete and fully conveys the scope of the inventive concept to one skilled in the art. In the drawings, the thicknesses of layers and regions may be exaggerated for clarity. Like numbers refer to like elements throughout.

Embodiments of the present inventive concept are described herein with reference to plan and cross-section illustrations that are schematic illustrations of idealized embodiments of the present inventive concept. As such, variations from the shapes of the illustrations as a result, for example, of manufacturing techniques and/or tolerances, are to be expected. Thus, embodiments of the present inventive concept should not be construed as limited to the particular shapes of regions illustrated herein but are to include deviations in shapes that result, for example, from manufacturing. Thus, the regions illustrated in the figures are schematic in nature and their shapes are not intended to illustrate the precise shape of a region of a device and are not intended to limit the scope of the present inventive concept.

In the present specification, measurement of focal variations of a photolithography apparatus may include measuring a focal position and measuring the influence of focal variations.

In the present specification, the terms “measurement” and “inspection” may be interchangeably used.

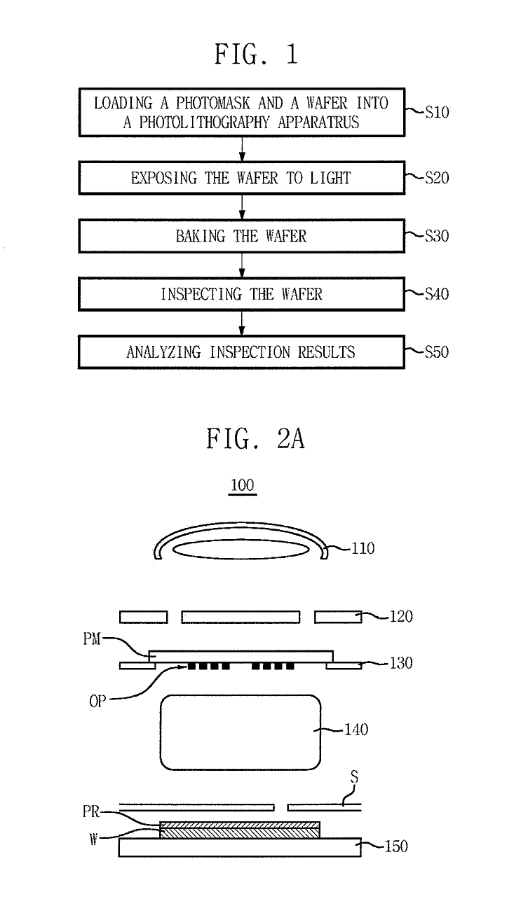

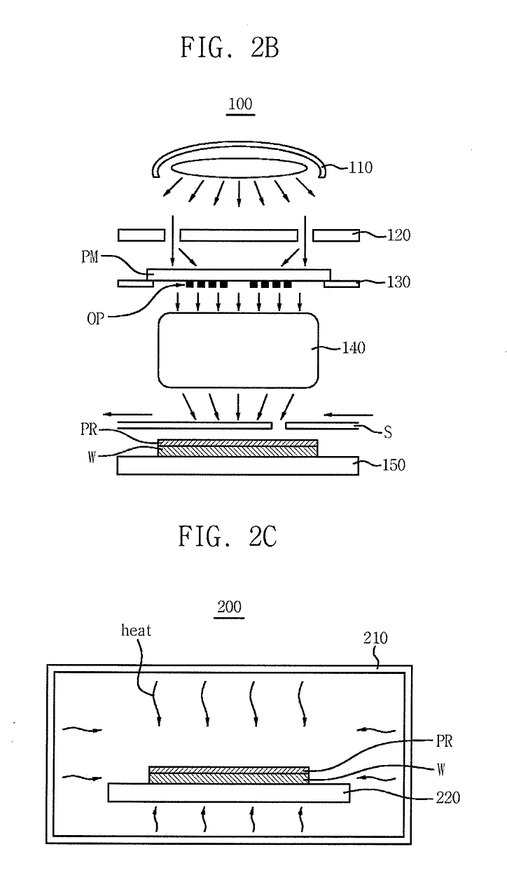

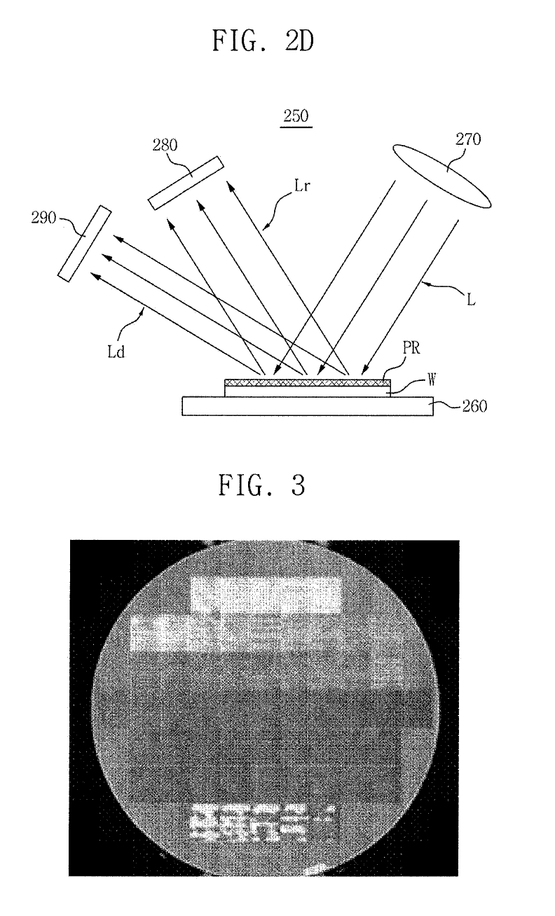

FIG. 1 is a flowchart illustrating a method of measuring focal variations of a photolithography apparatus according to exemplary embodiments of the inventive concept, and FIGS. 2A through 2D are schematic diagrams illustrating the method of FIG. 1.

Referring to FIGS. 1 and 2A through 2D, a method of measuring focal variations of a photolithography apparatus 100 according to exemplary embodiments of the inventive concept may include loading a photomask PM and a wafer W into the photolithography apparatus 100 (S10). An exposure process may be performed (S20). During the exposure process, an optical image of the photomask PM may be transferred to the wafer W using ultraviolet (UV) light irradiated from a light source 110. The wafer W may be baked (S30). Thereafter, the wafer W may be inspected (S40). The inspection results of the wafer W may be analyzed (S50). In addition, the method may further include setting an optimal focus of the photolithography apparatus 100 based on the analysis results. The photolithography apparatus 100 may be an apparatus configured to measure focal variations.

The photolithography apparatus 100 may include the light source 110, an off-axis illumination (OAI) system 120, a photomask stage 130, a projection lens 140, and a wafer stage 150. The photolithography apparatus 100 may be a transparent illumination system. For example, the photolithography apparatus 100 may be a scanner having a slit S. The light source 110 may generate UV light, such as g-line light, i-line light, KrF light, ArF light, or F2 light. The KrF light and the ArF light may mean a KrF light source or an ArF light source. The wavelength of light irradiated by the light source 110 may be as short as possible in order to maximize the effects of the inventive concept. Thus, in the present embodiments, an ArF light source may be used as the light source 110. The OAI system 120 may be a blind system or include apertures. The OAI system 120 may include a dipole aperture advantageous to forming a line-and-space pattern or similar apertures. Since the shapes of the OAI system 120 and the dipole aperture are known to one skilled in the art, a detailed description thereof will be omitted here. The similar apertures may include dinular apertures including split annular or bull's eyes. When the method according to the present embodiments is applied to the OAI system 120, the effects of the inventive concept may be further increased. The photomask stage 130 may be a position where the photomask PM will be mounted. The projection lens 140 may transfer the optical image of the photomask PM to the wafer W.

Referring to FIGS. 1 and 2A, the photomask PM and the wafer W may be loaded into the photolithography apparatus 100 (S10). More specifically, the photomask PM may be located at the photomask stage 130 of the photolithography apparatus 100, while the wafer W may be located on the wafer stage 150 thereof. A photoresist layer PR may be formed on the wafer W.

The photomask PM may include an optical pattern OP capable of measuring focal variations of the photolithography apparatus 100. The optical pattern OP may include transparent areas and opaque areas. When the photolithography apparatus 100 is a reflective system, the photomask PM may be a mirror with an optical pattern, and the optical pattern of the mirror may include reflective areas and light absorption areas. The optical pattern OP of the photomask PM may be a line-and-space pattern. For example, the transparent areas and the opaque areas may respectively correspond to lines and spaces or spaces and lines. In general, the OAI system 120 may be set according to the shape and/or pitch of a desired pattern. In other words, the OAI system 120 may be variously configured to have an optimal pattern pitch. According to the inventive concept, when the pitch of the optical pattern OP is about twice the optimal pattern pitch of the OAI system 120, the depth of focus (DOF) of the optical pattern OP may approximate zero (0). When the DOF of the optical pattern OP approximates 0, it is difficult to image the optical pattern OP on the wafer W. In other words, when the optical pattern OP has a narrow DOF, the optical pattern OP may be very sensitive to the focal variations of the photolithography apparatus 100. This is well known as the Rayleigh's Principle of Resolutions. Since a relationship between the OAI system 120 and its optimal pitch is very complicated, variously calculated and set, and known to one skilled in the art, a detailed description thereof will be omitted. A pitch of the optical pattern OP (i.e., line-and-space pattern) may be set to approximately twice the optimal pitch of the OAI system 120. That is, the pitch of the optical pattern OP may not be set to exactly twice the optimal pitch of the OAI system 120. This is because the present inventive concept may require a DOF of not precisely 0 but approximately 0. According to the inventive concept, the pitch of the optical pattern OP may be set to approximately twice the optimal pitch of the OAI system 120. In the present embodiments, experiments were conducted under conditions in which the pitch of the optical pattern OP was set to approximately 1.8 to 1.9 times the optimal pitch of the OAI system 120. Of course, the inventive concept is not limited to the above-described numerical values. In addition, according to exemplary embodiments, the OAI system 120 may include a quadrupole aperture or an annular aperture, and the optical pattern OP may be a contact pattern. Since the line-and-space pattern is a 1-dimensionally arranged pattern and the contact pattern is a 2-dimensionally arranged pattern, the influences of optical patterns having different shapes may be further measured. These various exemplary embodiments may be fully applied and executed within the spirit and scope of the present inventive concept.

The wafer W may be used in a process of measuring the focus of the photolithography apparatus 100. However, even a real wafer used in a real semiconductor fabrication process may be applied to a process of measuring the focus of the photolithography apparatus 100. In the present specification, processing the wafer W may be interpreted as processing the photoresist layer PR formed on the wafer W. In addition, a physical pattern may be formed between the surface of the wafer W and the photoresist layer PR. The presence or absence of the physical pattern on the surface of the wafer W should not be excluded from the technical scope of the present inventive concept. That is, the presence or absence of the physical pattern on the surface of the wafer W may be included in the present inventive concept.

Referring to FIGS. 1 and 2B, the optical pattern OP may be optically projected on the wafer W due to UV light (S20). Specifically, UV light irradiated by the light source 110 may be transmitted through the photomask PM and the projection lens 140 and irradiated to the photoresist layer PR formed on the wafer W. The projection process may be performed throughout the wafer W not once but several times. During the projection process, the UV light transmitted through the projection lens 140 may be projected on the wafer W through the slit S. The slit S may be moved in one direction during the projection process. For example, FIG. 2B illustrates the projection process under the assumption that the slit S moves from right to left in directions indicated by arrows. A region of the wafer W that may be exposed using the photomask PM due to a one-time exposure process may be only a tenth, twentieth, etc. of the entire area of the wafer W and called a shot region. That is, the entire area of the wafer W may be comprised of dozens of shot regions. The photoresist layer PR exposed to the UV light may include exposed areas and unexposed areas corresponding respectively to the transparent areas and opaque areas of the optical pattern OP. During the projection process, the focus of the photolithography apparatus 100 may be varied. For example, when the respective shot regions are exposed to light, the focus of the photolithography apparatus 100 may be adjusted to various positions according to an executor's intention. This experiment may provide basic data to predict the results of patterning due to a variation of each focus of the photolithography apparatus 100. Alternatively, all the shot regions may be exposed at the same focus positions. This experiment may provide trend data on variations in the foci of the respective regions of the wafer W. Since a scanner exposes one shot region through a slit using a scanning process, the scanner may provide greater variations between the foci of the respective shot regions than a stepper. Accordingly, the scanner may further increase the effects of the inventive concept.

Referring to FIGS. 1 and 2C, the exposed wafer W may be unloaded from the photolithography apparatus 100 and loaded and baked in a bake apparatus 200 (S30). The bake apparatus 200 may include a housing 210 and a wafer mounting table 220 and a heating unit (not shown) that are installed in the housing 210. The wafer mounting table 220 may rotate or move up and down. The heating unit may include a coil or a lamp. In addition, the heating unit may be heated to a temperature of about several tens to one hundred and several tens of ° C. in the bake apparatus 200. Specifically, the photoresist layer PR may be baked at a glass transition temperature or lower for several tens of seconds to several minutes. During the baking process, volatile components, such as a solvent, may be removed from the photoresist layer PR, and a chemical reaction of the photoresist layer PR may be facilitated or controlled. Specifically, a chemical reaction of a photo acid generator (PAG) or a photo active compound (PAC) may be facilitated in the exposed areas. Since the glass transition temperature depends on the kind and components of the photoresist layer PR, a description thereof will be omitted except that the glass transition temperature is set to a temperature of several tens to one hundred and several tens of ° C.

Referring to FIGS. 1 and 2D, the wafer W may be unloaded from the bake apparatus 200, loaded onto a measurement stage 260 of a measurement apparatus 250, and inspected (S40). In the measurement apparatus 250, light L for measurement may be irradiated from a measurement light source 270 to the wafer W, reflected by the wafer W, and collected by a diffracted light receiving unit 290. The diffracted light receiving unit 290 may collect a diffracted light component of reflected light. Diffracted light Ld may be reflected at a different angle from reflected light Lr. In general, an angle at which light is reflected may be equal to an angle at which light is diffracted unless there are special variables. In other words, the reflected light Lr is collected by a reflected light receiving unit 280. However, the diffracted light Ld may form a predetermined angle with the reflected light Lr. Since the predetermined angle depends on the physical and optical properties of respective materials, providing specific numerical values of the predetermined angle would be insignificant. The diffracted light Ld may be collected because the diffracted light receiving unit 290 is installed in a direction in which the diffracted light Ld travels. That is, diffracted light that does not travel in a direction in which reflected light Lr or 0th order diffracted light travels may be collected by the diffracted light receiving unit 290 installed in a direction toward the collected diffracted light. Since the intensity of ±2nd or greater than ±2nd diffracted light is sharply reduced, the intensity of 0th or ±1st diffracted light may not be affected. That is, the inventive concept may be applied by collecting the diffracted light Ld. The reflected light Lr may be interpreted as 0th order diffracted light and the diffract light Ld may be ±1st diffracted light. As the result of various experiments, the present inventive concept employs the ±1st order diffracted light Ld because more precise analysis results may be obtained than when 0th order diffracted light Lr is collected. That is, the ±1st order diffracted light Ld may be more sensitive to the focal variations of the photolithography apparatus 100 than the 0th order diffracted light Lr. The measurement apparatus 250 may be an apparatus configured to inspect the optical properties of the photoresist layer PR. The measurement apparatus 250 may irradiate the light L for measurement to the entire surface of the photoresist layer PR at a time (or simultaneously) and collect reflected light. The light L for measurement may be single-color light or mixed-color light. For example, the light L for measurement may be visible (V) light or light including several single-color light beams, such as RGB light beams. In the present embodiments, the light L for measurement may be interpreted as V light including RGB light beams.

Thereafter, inspection results may be analyzed (S50). Optical information on the collected diffracted light Ld for measurement may be converted into graphic images. The graphic images may be converted into digital images. The digital images may include RGB information indicated by numerical values. In the present specification, the numerical information may be interpreted as gradation information. In addition, the digital images may be converted into digital images of respective single-color light beams included in the diffracted light Ld for measurement, for example, a digital image of red light, a digital image of green light, and a digital image of blue light. In other words, the digital images may be converted into digital images extracted according to RGB colors. The digital images of respective color light beams may include gradation information thereon. The gradation information on the respective color digital images may include information not only on color but also on brightness and/or chroma. The respective color digital images separated and analyzed according to the RGB light may linearly present information on the focal position of the photolithography apparatus 100 in different wavelengths of focal positions. For example, a green digital image may provide a linear variation within the focal position range of 0±50 nm, a red digital image may provide a linear variation within the focal position range of 50±50 nm, and a blue digital image may provide a linear variation within the focal position range of −50±50 nm. This is only an example. The digital images may be variously affected by the light source 110 of the photolithography apparatus 100, an OAI method, the photomask PM, the shape and pitch of the optical pattern OP, the photoresist layer PR, and other various variables. Therefore, it may be difficult to conclude which color provides a predetermined range of focal variations. In addition, when several single-color light beams are separately analyzed, analysis results may be sensitively changed within different wavelength ranges. Accordingly, it can be seen that a variation in the focal position of the photolithography apparatus 100 is closely associated with light wavelength.

Furthermore, the graphic images obtained using the collected diffracted light Ld for measurement may be converted into grayscale images. Grayscale is a technique of providing black-and-white images. In the present specification, the grayscale may be interpreted as a term including a black-and-white image. When the graphic image is converted into the grayscale image, optical degrees may be concentrated on brightness information.

The exposed areas of the photoresist layer PR may have different physical and chemical properties from the unexposed areas thereof. Specifically, the exposed areas of the photoresist layer PR may have different light reflection rates and/or transmission rates from the unexposed areas thereof. Thus, optical information on the diffracted light Ld for measurement collected by the exposed areas of the photoresist layer PR may differ from optical information on the diffracted light Ld for measurement collected by the unexposed areas thereof. Presumably, this is because the focal variations of the photolithography apparatus 100 affect the intensity or energy of light irradiated to the exposed area of the photoresist layer PR. When the energy of light irradiated to the exposed area of the photoresist layer PR is varied according to a shot region, the extent of a chemical reaction caused in the corresponding exposed area may be varied. Accordingly, the optical information may include various optical properties of the photoresist layer PR caused by the focal variations of the photolithography apparatus 100. Therefore, reflected light beams for measurement, which are collected by the exposed areas, may exhibit various intensities.

Furthermore, the photolithography apparatus 100 may be set to an optimal focal position based on the analysis results of the photoresist layer PR. When either the focus of the photolithography apparatus 100 is preset, the influence of the focus of the photolithography apparatus 100 is negligible, or focus information serves only as a reference, the focus of the photolithography apparatus 100 may remain intact. Subsequently, a semiconductor fabrication process may be performed.

FIG. 3 is a graphic image taken while varying the focus of the photolithography apparatus 100 according to exemplary embodiments of the inventive concept. Specifically, while varying the focus of the photolithography apparatus 100 from an optimal focus to −200 nm and to +200 nm, the photoresist layer PR formed on the wafer W is exposed, baked, developed, and irradiated with light L for measurement, reflected diffracted light Ld is collected to form a first color graphic image, and the first color graphic image is converted into a black-and-white image of FIG. 3. Referring to FIG. 3, the farther the focus of the photolithography apparatus 100 is from an optimal focus, the more serious variations of colors (or brightness) of the respective shot regions become. In a lower portion of the graphic image of FIG. 3, one shot region shows uneven color. This may be because the photoresist layer PR is irregularly patterned during a developing process. The first color graphic image is provided to increase a color difference for brevity.

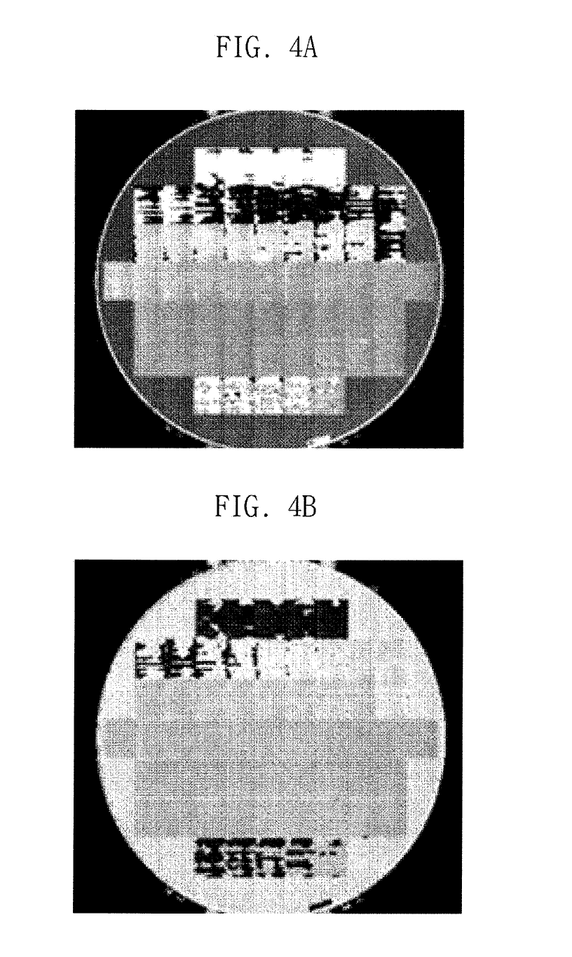

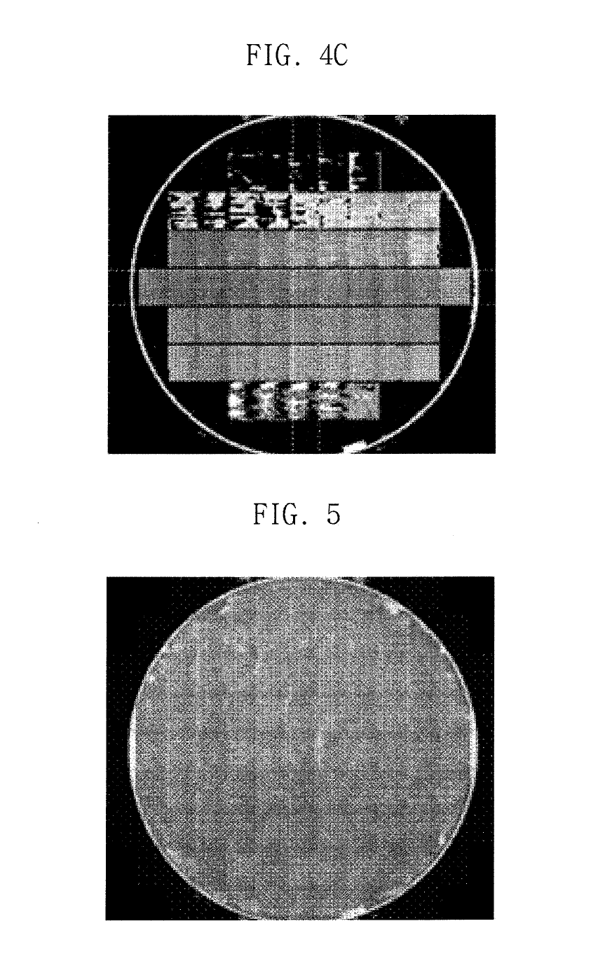

FIGS. 4A through 4C are black-and-white images into which gradation values of the first color graphic image, which are extracted according to RGB colors, are converted. Specifically, FIG. 4A is a red black-and-white image obtained by extracting a red component from the first color graphic image, FIG. 4B is a green black-and-white image obtained by extracting a green component from the first color graphic image, and FIG. 4B is a blue black-and-white image obtained by extracting a blue component from the first color graphic image. Referring to FIGS. 4A through 4C, the respective shot regions show different optical information according to respective colors. Specifically, FIGS. 4A through 4C illustrate more sensitive or insensitive bands. That is, it can be seen that the focal variations of the photolithography apparatus 100 are shown more precisely in a certain color according to each band.

FIG. 5 is a graphic image taken while varying the focus of the photolithography apparatus 100 according to exemplary embodiments of the inventive concept. Specifically, while varying the focus of the photolithography apparatus 100 from an optimal focus to −200 nm and to +200 nm, the photoresist layer PR is exposed, baked, and irradiated with light L for measurement without a developing process, reflected diffracted light Ld is collected to form a second color graphic image, and the second color graphic image is converted into a black-and-white image of FIG. 5. Referring to FIG. 5, there is no sharp color variation as compared with the first color graphic image. This is because a variable obtained during irregular patterning of the photoresist layer PR is excluded from the developing process. Thus, more precise analysis results may be obtained.

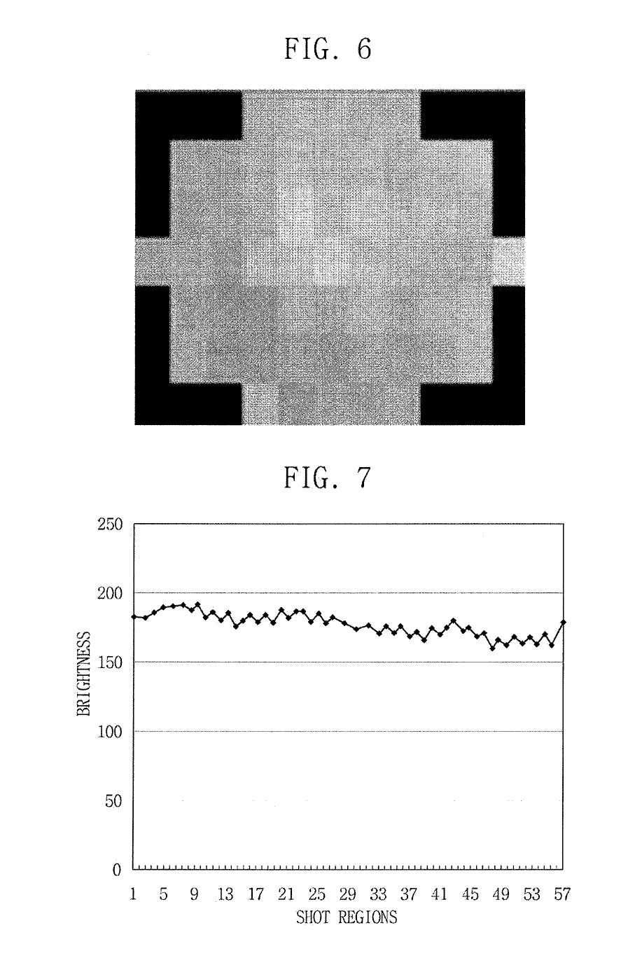

FIG. 6 is a first brightness black-and-white image that is obtained by converting the second color graphic image from which a red brightness component is extracted into a black-and-white image. Referring to FIG. 6, the respective shot regions are averaged. A variation in brightness, which is invisible to the naked eye, is clearly shown in the second color graphic image. In addition, shot regions disposed in an edge of the wafer W are excluded from analysis.

FIG. 7 is a graph showing the first brightness image according to each shot region. In FIG. 7, an abscissa denotes the order of shot regions, and an ordinate denotes analyzed brightness values. The brightness values may be interpreted as intensities. Referring to FIG. 7, from an approximate analysis of brightness information on the shot regions, it can be seen that the brightness of the shot regions linearly varies with focal variations of the photolithography apparatus 100.

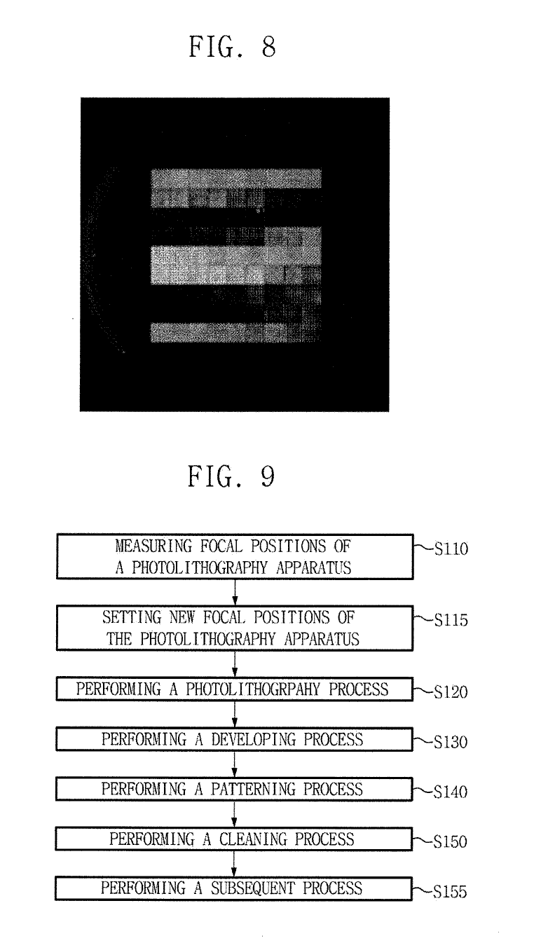

FIG. 8 is a black-and-white graphic image obtained by converting color graphic images obtained according to exemplary embodiments of the present inventive concept into grayscale images. The graphic image of FIG. 8 is slightly exaggerated to facilitate the understanding of the inventive concept. Referring to FIG. 8, it can be observed by grayscale that the properties of the photoresist layer PR vary with focal variations of the photolithography apparatus 100. That is, the influence of the focal variations of the photolithography apparatus 100 on the shape of a photoresist pattern to be formed on the wafer W may be predicted. Grayscale analysis may be less precise and faster than color analysis. Thus, color images or black-and-white images may be selected depending on the range of focal variations of a photolithography apparatus and a desired degree of precision and the influence of the focal variations of the photolithography apparatus may be analyzed using the selected images. In order to further enhance productivity, grayscale analysis may be more advantageous to color analysis if analysis errors are negligible.

According to the exemplary embodiments, the influence of focal variations of a photolithography apparatus on patterns to be formed on a wafer may be analyzed very precisely. Therefore, an optimal focus of the photolithography apparatus may be predicted and determined according to the shape and/or pitch of the patterns to be formed on the wafer.

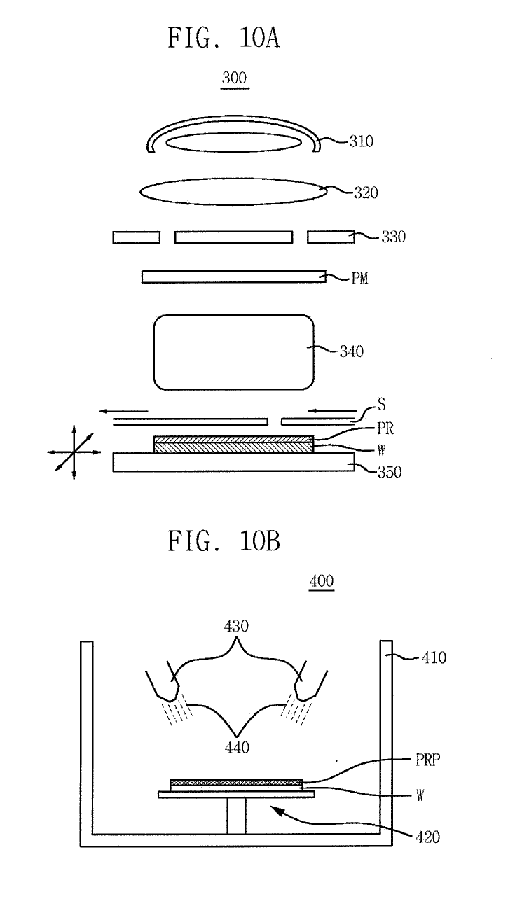

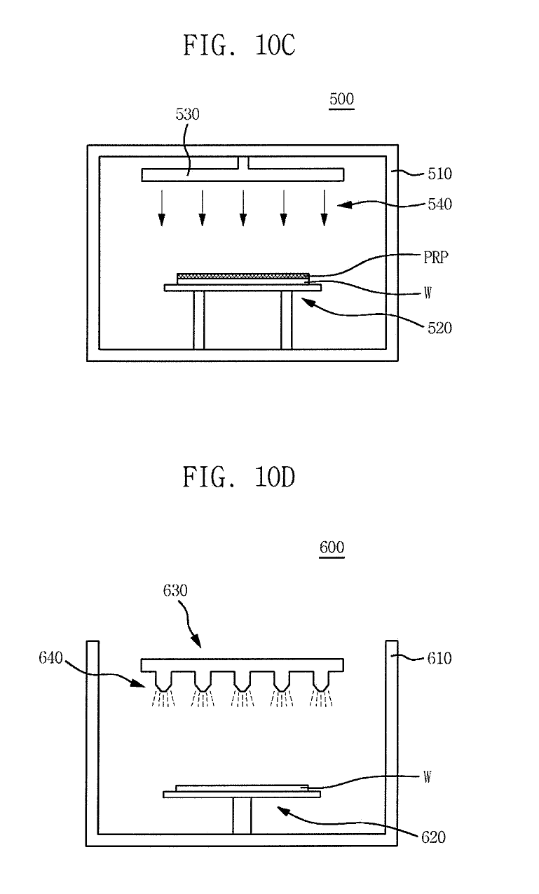

FIG. 9 is a flowchart illustrating a method of fabricating a semiconductor device using a method of measuring focal variations of a photolithography apparatus according to exemplary embodiments of the inventive concept, and FIGS. 10A through 10D are schematic diagrams illustrating the method of FIG. 9.

Referring to FIG. 9, a method of fabricating a semiconductor device using a method of measuring a focal variation of a photolithography apparatus according to exemplary embodiments of the inventive concept may include measuring a focal position of the photolithography apparatus (S110). A photolithography process may be performed using the photolithography apparatus (S120). A developing process may be performed (S130). A patterning process may be performed (S140). Thereafter, a cleaning process may be performed (S150). In addition, the method of fabricating the semiconductor device may further include setting the focal position of the photolithography apparatus (S115). After the cleaning process is finished (S150), a subsequent semiconductor fabrication process may be performed (S155).

Referring to FIGS. 9 and 10A, the influence of focal variations of a photolithography apparatus 300 on a pattern to be formed may be measured. The process of measuring the focus of the photolithography apparatus 300 may be performed periodically or temporarily if required. The process of measuring the focal position of the photolithography apparatus 300 may be understood with reference to FIGS. 1 and 2A through 2D. Afterwards, an optimal focal position of the photolithography apparatus 300 may be set based on the measurement result if required (S115). In operation S115, the focal position of the photolithography apparatus 300 may be adjusted by moving a wafer stage 350 of the photolithography apparatus 300 in all directions indicated by arrows.

Referring again to FIGS. 9 and 10A, the photolithography process may be performed using the photolithography apparatus 300 whose focal position is measured (S120). Initially, the photolithography process may include loading a wafer W into the photolithography apparatus 300. The photolithography apparatus 300 may include a light source 310, a condenser lens 320, a beam shaper 330, a projection lens 340, and a wafer stage 350. The wafer W may be loaded on the wafer stage 350. The light source 310 may generate UV light with a very short wavelength, such as i-line light, KrF light, or ArF light. The condenser lens 320 may prevent the UV light from deviating from a light path. The beam shaper 330 may be an aperture configured to define the shape of beams. FIG. 10A illustrates a longitudinal section that covers various apertures. For example, the beam shaper 330 may be a dipole aperture, a quadrupole aperture, an annular aperture, or one of other various apertures such as a split annular aperture, and bull's eyes aperture. That is, the beam shaper 330 may be an OAI illumination system. The photolithography apparatus 300 may include a photomask PM. That is, the photomask PM may be mounted on the photolithography apparatus 300. The photomask PM may include an optical pattern to be transferred to the wafer W. The projection lens 340 may transfer the optical pattern to the wafer W. The wafer W may include the photoresist layer PR. Referring to FIGS. 9 and 10A, UV light irradiated by the light source 310 may be transmitted through the condenser lens 320, the beam shaper 330, the photomask PM, and the projection lens 340 and irradiated to the wafer W. In other words, the optical pattern of the photomask PM may be reduced and transferred to the photoresist layer PR formed on the surface of the wafer W.

Referring to FIGS. 9 and 10B, the wafer W may be developed (S130). More specifically, the photoresist layer PR formed on the wafer W may be patterned using a chemical process to form a photoresist pattern PRP. The current developing process may be performed in a developing apparatus 400. The developing apparatus 400 may include a housing 410, a wafer support 420, and a developing nozzle 430. The wafer support 420 may rotate. The developing nozzle 430 may supply a developer 440 to the wafer W.

Referring to FIGS. 9 and 10C, the wafer W may be patterned using the photoresist pattern PRP as a patterning mask. Alternatively, a material layer formed between the wafer W and the photoresist pattern PRP may be patterned (S140). The current patterning process may be performed in a patterning apparatus 500. The patterning apparatus 500 may include a chamber 510, a wafer chuck 520 on which the wafer W is loaded and a gas supplier 530 configured to supply a patterning gas 540. The patterning gas 540 may be excited to generate plasma.

Referring to FIGS. 9 and 10D, the photoresist pattern PRP may be removed, and the wafer W may be cleaned (S150). The process S150 may be performed in a cleaning apparatus 600. The cleaning apparatus 600 may include a tub 610, a wafer mounting table 620, and cleaning nozzles 630. The cleaning nozzles 630 may supply a cleaning solution 640 to the wafer W. As a result, a one-step semiconductor fabrication process according to exemplary embodiments may be completed, and a subsequent semiconductor fabrication process may be performed (S155).

The names and functions of other not-shown components may be easily understood with reference to other drawings and descriptions of the present specification.

According to the exemplary embodiments as described above, focal variations of the entire wafer may be measured and numerically expressed, and focal variations of a portion of the wafer may also be sensed. In addition, since the focal variations of the wafer may be accurately measured at a high speed, productivity can be increased.

While exemplary embodiments have been disclosed herein, it should be understood that other variations may be possible. Such variations are not to be regarded as a departure from the spirit and scope of exemplary embodiments of the present inventive concept, and all such modifications as would be understood by one skilled in the art are intended to be included within the scope of the following claims.

1. A method of measuring focal variations of a photolithography apparatus, comprising:
loading a photomask and a wafer into the photolithography apparatus, the photomask having an optical pattern, and the wafer having a photoresist layer on a top surface thereof;
transferring an image of the optical pattern to the photoresist layer using ultraviolet (UV) light;
baking the photoresist layer;
inspecting the photoresist layer; and
analyzing inspection results of the photoresist layer,
wherein inspecting the photoresist comprises:
irradiating light for measurement to the entire surface of the wafer; and
collecting light reflected and diffracted by the wafer to form an optical image, and
wherein analyzing the inspection results of the photoresist layer comprises analyzing optical information on the optical image.

2. The method of claim 1, wherein the diffracted light is light transmitted through and diffracted by the photoresist layer.

3. The method of claim 1, wherein inspecting the photoresist layer comprises inspecting the photoresist layer without developing the photoresist layer.

4. The method of claim 1, wherein transferring the image of the optical pattern to the photoresist layer using the UV light comprises repeating, a plurality of times, a unit process of transferring the image of the optical pattern to a unit area corresponding to a portion of the entire wafer.

5. The method of claim 4, wherein repeating the unit process a plurality of times is performed using a plurality of foci.

6. The method of claim 4, wherein the light for measurement comprises red, green, and blue (RGB) light.

7. The method of claim 6, wherein analyzing the optical information on the optical image comprises converting the optical image into a digital image and analyzing gradation of the digital image.

8. The method of claim 7, wherein analyzing the gradation of the digital image comprises analyzing the gradation of the digital image according to the unit area.

9. The method of claim 8, wherein analyzing the gradation of the digital image comprises extracting RGB values of the gradation of the digital image.

10. The method of claim 8, wherein analyzing the gradation according to the unit area comprises converting the gradation of the digital image into a grayscale image.

11. The method of claim 1, wherein the photolithography apparatus comprises an off axis illumination (OAI) system.

12. The method of claim 11, wherein the OAI system comprises a dipole aperture.

13. The method of claim 1, wherein the optical pattern is a line-and-space pattern.

14. The method of claim 13, wherein a pitch of the line-and-space patterns is at least about 1.8 times an optimum pitch of the OAI system.

15. The method of claim 1, wherein the UV light is light irradiated from a KrF or ArF light source.

16. The method of claim 15, wherein the photolithography apparatus is a scanner including a slit.

17. The method of claim 16, wherein baking the photoresist layer comprises heating the photoresist layer at a glass transition temperature or lower.

18. A method of measuring focal variations of a photolithography apparatus, comprising:
loading a photomask and a wafer into a photolithography apparatus, the photomask having an optical pattern, and the wafer having a photoresist layer on a top surface thereof;
transferring an image of the optical pattern to the photoresist layer using UV light;
baking the photoresist layer;
inspecting the photoresist layer without developing the photoresist layer; and
analyzing inspection results of the photoresist layer,
wherein inspecting the photoresist layer comprises:
irradiating visible (V) light for measurement to the entire photoresist layer; and
collecting light reflected and diffracted by the wafer to form an optical image, and
wherein analyzing the inspection results of the photoresist layer comprises analyzing optical information on the optical image.

19. The method of claim 18, further comprising converting the optical image into a black-and-white digital image,
wherein analyzing the inspection results of the photoresist layer comprises analyzing brightness information on the black-and-white digital image.

20. (canceled)
